(19) United States
(12) Patent Application Publication
(10) Pub. No.: US 2017/0054790 A1
(43) Pub. Date: Feb. 23, 2017

(54) System and Method for Object Compression and State Synchronization

(71) Applicant: Neatly Co., Denver, CO (US)

(72) Inventor: Mark McCubbin, San Rafael, CA (US)

(73) Assignee: Neatly Co., Denver, CO (US)

(21) Appl. No.: 15/241,341

(22) Filed: Aug. 19, 2016

Related U.S. Application Data
(60) Provisional application No. 62/208,352, filed on Aug. 21, 2015.
(60) Provisional application No. 62/208,372, filed on Aug. 21, 2015.
(60) Provisional application No. 62/208,330, filed on Aug. 21, 2015.
(60) Provisional application No. 62/208,346, filed on Aug. 21, 2015.

(51) Int. Cl. H04L 29/08; H04L 29/06; G06F 3/0484

(52) U.S. Cl. CPC H04L 67/06; G06F 3/04842; H04L 69/04; H04L 67/42; H04L 67/1095; H04M 1/72522

(57) ABSTRACT

Embodiments of the disclosure provide systems and methods for compressing network transportable objects exchanged between devices and synchronizing object state between those devices based on the transportable objects. According to one embodiment, the server can maintain a user state between multiple clients on which an interface described in a Domain Specific Language (DSL) is rendered. To maintain this user state, the server can automatically merge conflicts between clients and between the clients and server, synchronize object state between the clients and server, and automatically commit changes.

### CROSS REFERENCE TO RELATED APPLICATION

The present application claims the benefits of U.S. Provisional Application Ser. No. 62/208,352, filed Aug. 21, 2015, entitled “Object Compression”, U.S. Provisional Application Ser. No. 62/208,372, filed Aug. 21, 2015, entitled “State Synchronization”, U.S. Provisional Application Ser. No. 62/208,330, filed Aug. 21, 2015, entitled “Dynamic Encryption and Decryption” and U.S. Provisional Application Ser. No. 62/208,346, filed Aug. 21, 2015, entitled “Encrypted Data Retrieval”, all of which are incorporated herein by this reference in their entireties.

### FIELD OF THE DISCLOSURE

Embodiments of the present disclosure relate generally to methods and systems for transforming and displaying information on various devices and more particularly to compression and synchronization of object state between various devices.

### BACKGROUND

In certain software and electronic device applications, rapidly accessing backend data may prove difficult. For example, in software as a service (SaaS) there are two major front-facing components: the client software and the server that hosts the Application Programming Interface (API). These components provide a user access to backend data. However, in data-intensive applications, this process and component configuration can because time consuming and error prone for developers. For example, for a legal application on an electronic device such as a mobile phone, a user may require near constant access to legal documents on a backend server.

### BRIEF SUMMARY

According to one embodiment, a Domain Specific Language (DSL) can be used to describe both the flow of an application and the data from the backend Application Program Interface (API) for that application. A player on a server can render the DSL on one or more client communication devices which can be any given platform such as iOS, Android, or Web. A builder on the server can compile the DSL code and construct backend bindings for the API that correctly exposes the backend data to the client application. This system can help a user of the client communication device rapidly access the backend data of the application.

According to one embodiment, each client communication device can have stored therein a plurality of objects related to the application, wherein each object has a state. A transportable object in such a system can comprise state information for one or more of the plurality of objects on the device that have experienced a change in state. The server can receive such transportable objects from one or more of the clients when the state of an object on that client changes.

Embodiments of the disclosure provide systems and methods for compressing network transportable objects exchanged between devices and synchronizing object state between those devices based on the transportable objects. According to one embodiment, the server can maintain a user state between multiple clients on which the DSL is rendered. To maintain this user state, the server can automatically merge conflicts between clients and between the clients and server, synchronize object state between the clients and server, and automatically commit changes.

More specifically, a user state can be maintained by the server for each user as a discrete instance of that user. Actions by the user on a user device related to one of the plurality of objects on that device can result in an update to that object. Each update to an individual object contained within the user state can store changes as an atomic change list. Each change list can maintain time-stamp information and metadata that can be used to track whether the update is a critical state change (i.e., is immutable), a non-critical update (i.e., is potentially mergable), or a new object. Once these updates are received by the server through a transportable object, the atomic change lists can be applied by the server to the user state maintained by the server in the order they are received. Depending on heuristics on the server and based on the metadata of the change list, conflicts between actions such as destructive removals, additions, object replacements, etc. can be resolved.

According to one embodiment, the system may reduce network traffic and latency by more efficiently creating the network transportable objects and transmitting these objects between the client and server. More specifically, for each of the plurality of objects on the client, the client can maintain a previously transmitted state. When synchronization or transmission occurs or is desired, the client can compute differences between the previously transmitted state and the current state of that object as a series of data transforms which can be used to generate markup metadata that describes the changes since the last transmitted state. This markup metadata can be included in a transportable object for transmission to the server. When received by the server, the markup metadata can be translated back into the series of data transformations which can then be applied to the user state maintained by the server for synchronization with the client.

Stated another way, synchronizing a user state between a client device and a server, from the perspective of the client device, can begin with rendering a user interface on the client device. The user interface, such as an interface defined in DSL as described in detail above, can represent a plurality of objects on the client device. The plurality of objects can be related to an application executing on a server.

A user action through the rendered user interface can be detected. The user action can be related to at least one of the plurality of objects on the client device and can change a state of the at least one of the plurality of objects. For example, the user action can comprise anything from a click of a button represented in the user interface to the sending of a message such as an email or social media post, or even the editing, creation, or deletion of a file. In response to the detected user action, and as can be understood, the user interface can be updated on the device to reflect the action and result of that action.

A transportable object can be created based on the detected user action. The transportable object can comprise information describing the changing of the state of the at least one of the plurality of objects and can represent a current user state for the user relative to the application, i.e., based on that change. For example, the transportable object can comprise metadata identifying one or more of a transaction type, a unique transaction identifier, a transaction timestamp for the time when the transaction occurred, a user identifier for the user, or content of the transaction. Additionally or alternatively, the transportable object can comprise metadata identifying a change to the object as a critical state change that is immutable, a non-critical update that is potentially mergable, or a creation of a new object.

According to one embodiment, creating the transportable object based on the detected user action can be further based on stored information describing the previous user state sent to the server. In such cases, creating the transportable object based on the stored information describing the previous user state sent to the server can further comprise determining differences between the current user state and the previous user state sent to the server, defining the determined differences between the current user state and the previous user state sent to the server as a series of data transforms, and generating metadata of the transportable object describing the series of data transforms.

In either case, whether the transportable object is created based on a difference between a previous state and the current state or on the current state alone, information describing the user state can be recorded. When communication with the server is available, the created transportable object describing the user sate can be sent to the server

Synchronizing a user state between a client device and a server, from the perspective of the server, can begin with maintaining as a discrete instance, user state information for each user from a plurality of users of an application. A transportable object can be received. The transportable object can comprise information describing a change of a state by a user of the plurality of users of the at least one of the plurality of objects on the client device and related to an application on the server. The transportable object can represent a current user state for the user relative to the application. For example, the transportable object can comprise metadata identifying one or more of a transaction type, a unique transaction identifier, a transaction timestamp for the time when the transaction occurred, a user identifier for the user, or content of the transaction. In some cases, the received transportable object can comprise metadata describing changes to the state of the at least one of the plurality of objects since a last synchronization.

The information describing the change of the state of the at least one of the plurality of objects can be read from the received transportable object. An update can be applied to the maintained user state information for the user based on the information the information describing the change of the state of the at least one of the plurality of objects received in the transportable object. For example, when the received metadata describes changes since a last synchronization, applying the update to the maintained user state information for the user based on the information describing the change of the state of the at least one of the plurality of objects received in the transportable object can comprise translating the metadata of the received transportable object to a series of data transforms and applying the series of data transforms to the maintained user state information for the user. Applying the update to the maintained user state information for the user can also comprise resolving, by the server, conflicts between destructive removals, additions, and object replacements represented by the metadata of the transportable object. According to one embodiment, applying the update to the maintained user state information for the user can further comprise synchronizing the user state with one or more client communication devices for the user.

The present disclosure can provide a number of advantages depending on the particular aspect, embodiment, and/or configuration. The system and method of the present disclosure can provide the advantages of native performance, including lower latency, on principal client platforms, such as iOS, Android, and Web, enable rapid iteration that can easily implement basic features and only require custom code for unique feature development on each client platform, or enable easy customization, such as the ability to re-skin and update the flow of the entire application with minimum code. It can enable rapid implementation and deployment of cost effective applications in a SaaS model across multiple verticals, such as practice management and others. The system and method of the present disclosure can render different views on any selected client platform with the implementation being fully native and custom to each such selected client platform, whether iOS, Android, or Web. While the system and method can support dynamic application changes at runtime, they can output a custom client application with bindings that target efficient runtime performance and optimal download size. Changes made to objects on one or more client communication devices can be synchronized with the server and across devices in an efficient manner that reduces network traffic and latency.

### BRIEF DESCRIPTION OF THE DRAWINGS

FIG. 1 is a block diagram illustrating various components of a transformation system in which various embodiments of the present disclosure may be implemented.

FIG. 2 is a flowchart illustrating an exemplary client communication device process for object compression and state synchronization according to one embodiment.

FIG. 3 is a flowchart illustrating an exemplary server process for object compression and state synchronization according to one embodiment.

FIG. 4 is an exemplary code snippet illustrating contents of a transportable object according to one embodiment.

FIG. 5 is an exemplary code snippet illustrating contents of a transportable object according to another embodiment.

FIG. 6 is an exemplary code snippet illustrating contents of a transportable object according to yet another embodiment.

FIG. 7 is an exemplary code snippet illustrating contents of a registry for a user according to one embodiment.

FIG. 8 is a block diagram illustrating an exemplary hardware system upon which elements of the present disclosure may be implemented.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable storage medium” may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

A “container” refers to any component that can contain other components inside itself. In some markup languages, such as HTML, the container is the area enclosed by the beginning and ending tags. For example, <HTML> encloses an entire document while other tags may enclose a single word, paragraph, or other elements. In HTML code, all containers must have a start and stop tag to close the container.

“Data mapping” refers to a process of creating data element mappings between two distinct data models. Data mapping can be used as a first step for a wide variety of data integration tasks including: data transformation or data mediation between a data source and a destination, identification of data relationships as part of data lineage analysis, discovery of hidden sensitive data such as the last four digits social security number hidden in another user id as part of a data masking or de-identification project, or consolidation of multiple databases into a single data base and identifying redundant columns of data for consolidation or elimination.

The terms “determine,” “calculate,” and “compute,” and variations thereof, as used herein, are used interchangeably and include any type of methodology, process, mathematical operation or technique.

An “image file format” refers to a standardized means of organizing and storing digital images. Image files are composed of digital data in one of these formats that can be rasterized for use on a computer display or printer. An image file format may store data in uncompressed, compressed, or vector formats. Once rasterized, an image becomes a grid of pixels, each of which has a number of bits to designate its color equal to the color depth of the device displaying it. Raster formats include JPEG/JFIF, JPEG 2000, Exif, TIFF, GIF, BMP, PNG, PPM, PGM, PBM, PNM, WEBP, HDR, HEIF, BPG, and other raster and container formats. Vector formats include CGM, Gerber format, SVG, and other 2D or 3D vector formats. Metafile or compound formats are portable formats which can include both raster and vector information. Examples are application-independent formats such as WMF and EMF. The metafile format is commonly an intermediate format.

“Late binding”, or “dynamic binding” is a computer programming mechanism in which the method being called upon an object or the function being called with arguments is looked up by name at runtime. With early binding, or static binding, in an object-oriented language, the compilation phase fixes all types of variables and expressions. This is usually stored in the compiled program as an offset in a virtual method table (“v-table”) and can be very efficient. With late binding the compiler does not have enough information to verify that the method even exists let alone to bind to its particular slot on the v-table. Instead the method is looked up by name at runtime. The primary advantage of using late binding in Component Object Model (COM) programming is that it does not require the compiler to reference the libraries that contain the object at compile time.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

A “native application” or “native app” is an application program that has been developed for use on a particular platform or device. It is written in native code for that platform or device. Because native apps are written for a specific platform, they can interact with and take advantage of operating system features and other software that is typically installed on that platform. Because a native app is built for a particular device and its operating system, it has the ability to use device-specific hardware and software; that is, the native app can take advantage of the latest technology available on mobile devices such as a global positioning system (GPS) and camera.

“Native code” refers to computer programming (code) that is compiled to run with a particular microprocessor and its set of instructions (e.g., operating system). If the same program were to be run on a computer with a different processor, the code could execute only with software that enables the computer to emulate the original microprocessor. In this case, the program would run in “emulation mode” on the new processor and generally slower than in native mode on the original processor. Native code is different from bytecode (sometimes called interpreted code), a form of code that can be said to run in a virtual machine. The present disclosure uses “native” as referring to code that is compiled to run directly on a particular microprocessor and its set of instructions and not to run in emulation mode.

“Software rendering” refers to a process of generating an image from a model by means of computer software. In the context of computer graphics rendering, software rendering refers to a rendering process that is not dependent upon graphics hardware ASICs, such as a graphics card. The rendering takes place entirely in the CPU or microprocessor.

A “vector-based image” refers to an image created by a vector graphics editor, such as Adobe Illustrator or Corel Draw which is a computer program that allows users to compose, using mathematic equations and geometric primitives (points, lines, and shapes), and edit vectorgraphics images interactively on a computer and save them in one of many popular vectorgraphics formats, such as EPS, PDF, WMF, SVG, or VML. Vector graphics generally uses polygons to represent images in computer graphics. Vector graphics are generally based on vectors, which lead through locations called control points or nodes.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® CortexTMM processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Embodiments of the present disclosure relate generally to methods and systems for transforming and displaying information from an application on various devices and more particularly to compression and synchronization of object state between various devices. According to one embodiment, a transformation system is provided that transforms image information expressed in a first language, such as a markup language or domain specific language (“DSL”), into multiple native rendering languages of various target systems, such as a server, tablet computer, smart phone, laptop, or personal computer. By using native rendering languages for expressing the images, latency from user activation of an icon to display of the associated content can be substantially eliminated. DSL can be used to describe both the flow of an application and the data from the backend Application Program Interface (API) for that application. A player on a server can render the DSL on one or more client communication devices which can be any given platform such as iOS, Android, or Web. A builder on the server can compile the DSL code and construct backend bindings for the API that correctly exposes the backend data to the client application. This system can help a user of the client communication device rapidly access the backend data of the application.

According to one embodiment, each client communication device can have stored therein a plurality of objects, wherein each object has a state. A transportable object in such a system can comprise state information for one or more of the plurality of objects on the device that have experienced a change in state. The server can receive such transportable objects from one or more of the clients when the state of an object on that client changes.

Embodiments of the disclosure provide systems and methods for compressing network transportable objects exchanged between devices and synchronizing object state between those devices based on the transportable objects. According to one embodiment, the server can maintain a user state between multiple clients on which the DSL is rendered. To maintain this user state, the server can automatically merge conflicts between clients and between the clients and server, synchronize object state between the clients and server, and automatically commit changes.

More specifically, a user state can be maintained by the server for each user as a discrete instance of that user. Actions by the user on a user device related to one of the plurality of objects on that device can result in an update to that object. Each update to an individual object contained within the user state can store changes as an atomic change list. Each change list can maintain time-stamp information and metadata that can be used to track whether the update is a critical state change (i.e., is immutable), a non-critical update (i.e., is potentially mergable), or a new object. Once these updates are received by the server through a transportable object, the atomic change lists can be applied by the server to the user state in the order they are received. Depending on heuristics on the server and based on the metadata of the change list, conflicts between actions such as destructive removals, additions, object replacements, etc. can be resolved.

According to one embodiment, the system may reduce network traffic and latency by more efficiently creating the network transportable objects and transmitting these objects between the client and server. More specifically, for each of the plurality of objects on the client, the client can maintain a previously transmitted state. When synchronization or transmission occurs or is desired, the client can compute differences between the previously transmitted state and the current state of that object as a series of data transforms which can be used to generate markup metadata that describes the changes since the last transmitted state. This markup metadata can be included in a transportable object for transmission to the server. When received by the server, the markup metadata can be translated back into the series of data transformations which can then be applied to the user state maintained by the server for synchronization with the client.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

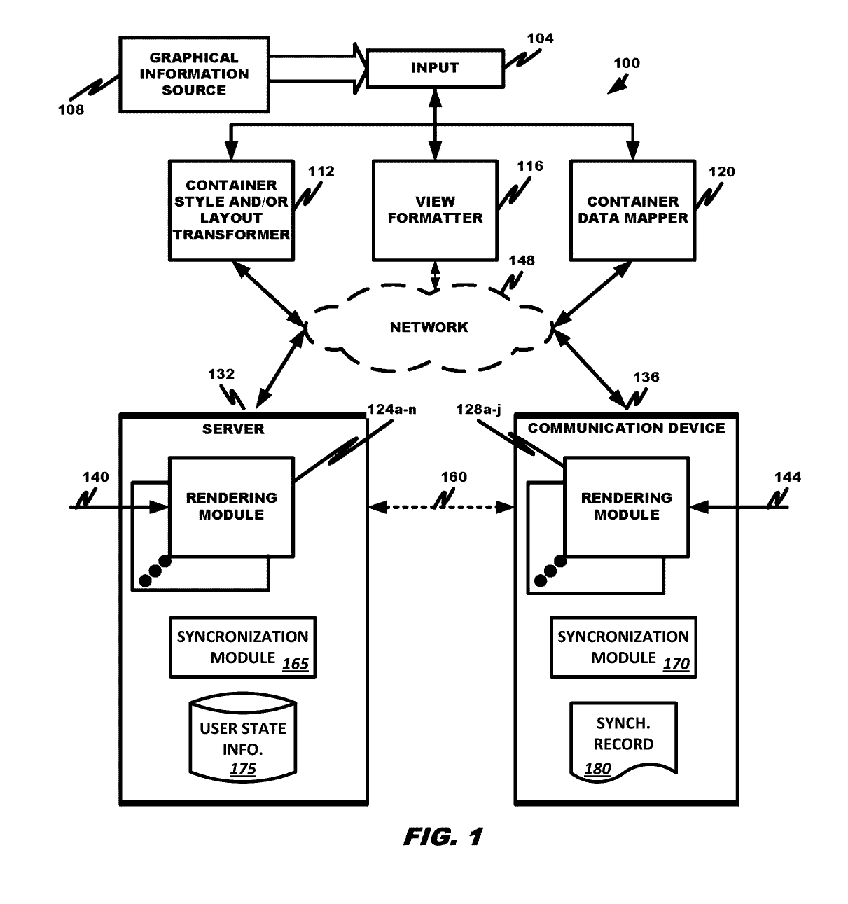

FIG. 1 is a block diagram illustrating various components of a transformation system in which various embodiments of the present disclosure may be implemented. As illustrated in this example, the transformation system 100 comprises an input 104 for receiving image information from a source 108 (such as a designer, application vendor, or another source), a container style and/or layout transformer 112 to convert the style and layout container information in the received graphical information into container information having a style and layout compatible with the style and layout capabilities of a target system (e.g., a server that hosts the application programming interface or API that provides a window or access into various services and a datastore or other database), tablet computer, smart phone, laptop, or personal computer) and expressed in a different user interface rendering language of the target system (e.g., a markup language, UIkit™ by Apple™, Travel ProUI Kit™, and others), a view formatter 116 to convert the view information in the received graphical information into view information having a format compatible with the format requirements or specifications of a target system and expressed in the different user interface rendering language of the target system, a container data mapper 120 to convert the data elements in the container into data structure descriptors compatible with the requirements of the target system and expressed in the different user interface rendering language of the target system, and one or more rendering modules 124a-n and 128a-j in each of the server 132 and communication device 136, respectively, that provides an appropriate template or structure to combine or merge the outputs (collectively denoted by arrows 140 and 144) of the container style and/or layout transformer 112, view formatter 116, and container data mapper 120 into a common graphical user interface for display by the target system. These elements are further described below and in greater detail in U.S. patent application Ser. No. 15/139,553, filed Apr. 27, 2016, and entitled “System and Method for Transforming Image Information for a Target System Interface” which is incorporated herein by reference in its entirety.

The container style and/or layout transformer 112, view formatter 116, container data mapper 120 and rendering modules may be interconnected by an optional network 148. The network 148 can be any distributed processing network used to communicate information between two or more computer systems. A network 148 can communicate in any protocol or format. The network 148 can be an intranet, the Internet, the World Wide Web, etc. It will be appreciated that in various embodiments, the container style and/or layout transformer 112, view formatter 116, container data mapper 120 may communicate with one or more of the rendering modules, communication device 136, or server 132 in the absence of a network 148.

While the target system(s) are depicted by the server 132 and communication device 136 (e.g., a tablet computer, smart phone, laptop, personal computer, or other computing device), it is to be appreciated that any number and types of target systems may receive the outputs 140 or 144 for display to a user.

The container style and/or layout transformer 112, view formatter 116, container data mapper 120 and rendering modules can be instructions recorded on a computer readable medium and executed by a common microprocessor on a common computational system or by multiple microprocessors on different computational systems. Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® CortexTMM processors, ARM® Cortex-A and ARM926EJ-S™ processors, other industry-equivalent processors, and may perform computational functions using any known or future-developed standard, instruction set, libraries, and/or architecture.

The container style and/or layout transformer 112 processes input style and layout information for containers in the received image information. As used herein, “input style and layout information” includes, for example, character set, (e.g., UTF-8), container type or family (e.g., icon, avatar, message, etc.), container size, container position in the view, container alignment, container color information, container width, container height, container float, container margin, container border (e.g., radius, width, style, and color), container padding (e.g., left and right), and other container style or layout variables.

The image formatter 116 converts the view information in the received image information into view information output having an image file format compatible with the image file format requirements or specifications of one or more target system(s). Stated differently, the view formatter 116 takes as input vector-based and/or regular images and preprocesses them to a native target system format, such as PNG, Fonts, and Vectors. For example, the view formatter 116 can convert a view from a first image file format or component thereof (e.g., resolution) to a different second image file format or component thereof for the target system(s).

The container data mapper 120 processes the data information in containers in the received image information. As used herein, “data information” includes, for example, data structures contained in a database or other computer readable medium. Examples of data structures include message content, records, data files, or other information stored as bits and bytes in a computer readable medium. By way of illustration, the container data mapper 120 takes the input 104 that specifies what data should be used in any given visual element or container and outputs correctly target system mappings for the data. The container data mapper 120 can be a compiler that receives input 104 and constructs the necessary backend bindings for an application program interface that exposes correctly all data to one or more client applications executing on the target system. The container data mapper 120 can bind data structures at runtime (e.g., late binding); however, the container data mapper 120 ensures that all data and flow defined for an application both exist and are connected correctly (e.g., there are no dead ends causing processing faults or errors).

The rendering modules 124a-n and 128a-j receive the input 140 and 144, respectively, which correlates to the output of the container style and/or layout transformer 112, view formatter, and container data mapper 120 and provides a template, scaffold, or other pattern or renderer for reference for merging the containers in the output of the container style and/or layout transformer 112, view formatter, and container data mapper 120 into a common display by the target system(s). The template can be, for example, a suite or collection of templates with dynamic data binding that allows full reuse and instances in any form. The template can be view output of the view formatter 116 that is stored as a template for current and later use. A target system can have only one rendering module 124 or 128 received as part of the input 140 or 144 or multiple rendering modules 124 or 128, depending on the application. Where the target system has multiple rendering modules 124 or 128, each of the rendering modules can have a unique identifier that is included in the input 140 to notify the microprocessor of the target system which rendering module 124 or 128 is to be used to merge the input 140 or 144. In one application, the rendering module(s) 124a-n in the server 132 is scaffolding, such as one or more of node JS scaffolding or Rails scaffolding, and the rendering module(s) 128a-j in the communication device 136 is one or more of an iOS renderer, Web renderer, Android renderer, and floating topic renderer. The scaffolding and renderer are native to the server and communication device, respectively.

The container style and/or layout transformer 112, view formatter 116, and container data mapper 120 can receive a common or different input 104 depending on the application. As described in the application entitled “System and Method for Transforming Image Information for a Target System Interface” referenced above and incorporated herein, the input 104 can be descriptively declared using a Domain Specific Language (“DSL”) that enables not only description of the entire flow of an application in a concise JavaScript Object Notation (“JSON”) format but also describes what data from a background application program interface is necessary to render visual components or containers for each customer view in an application. As will be appreciated, a DSL is a computer language, such as HTML, specialized to a particular application domain. DSLs can be further subdivided by the kind of language, and include domain-specific markup languages, domain-specific modeling languages (more generally, specification languages), and domain-specific programming languages. JSON is an open-standard format that uses human-readable text to transmit data objects consisting of attribute—value pairs.

The container style and/or layout transformer 112, view formatter 116, and container data mapper 120 can execute in parallel or serially in a pipelined configuration. As will be appreciated, a pipeline is a set of data processing elements connected in series, where the output of one element is the input of the next one. The elements of a pipeline are often executed in parallel or in time-sliced fashion; in that case, some amount of buffer storage is often inserted between elements. They can execute on a common microprocessor in a multithreaded configuration or different microprocessors. As will be appreciated, a thread of execution is the smallest sequence of programmed instructions that can be managed independently by a scheduler, which is typically a part of the operating system. The implementation of threads and processes differs between operating systems, but in most cases a thread is a component of a process. Multiple threads can exist within one process, executing concurrently (one starting before others finish) and share resources such as memory, while different processes do not share these resources. In particular, the threads of a process share its instructions (executable code) and its context (the values of its variables at any given time).

Where the container style and/or layout transformer 112, view formatter 116, and container data mapper 120 execute concurrently and not sequentially, synchronizing the output of the container style and/or layout transformer 112, view formatter, and container data mapper 120 with one another and to a common set of input 104 information can be done using an identifier and/or timestamp. The identifier can be a database storage location or address, packet sequence or identification number associated with transmission or receipt of the input 104, counter, or other identifier to correlate the output of the container style and/or layout transformer 112, view formatter, and container data mapper 120 with a common set of input 104 information. Alternatively or additionally, a timestamp, such as a timestamp or recording of a selected item of the input information 104 in a database, transmission of a selected item of the input information 104, or receipt of the selected item of the input information 104 can be employed. The identifier can be exchanged to determine or detect comparative latency in receipt of output by the server and communication device.

In the various embodiments of the disclosure, the particular arrangement and data flow through the optional network 148, or in the absence of the network 148, can take many forms for a variety of purposes (e.g., locating substantial amounts of data processing and storage on a server 132, minimizing the amount of data that is transmitted to the communication device 136, etc.). In an exemplary embodiment, the container style and/or layout transformer 112 and the view formatter 116 communicate directly with the communication device 136 while the data mapper 120 communicates through the network 148 with the server 132, and then the server 132 communicates with the communication device 136. In this arrangement, the container style and/or layout transformer 112 sends the layout and position output 220, which is translated from the input DSL to the chosen native rendering language of the communication device 136, to the communication device 136. Further, the view formatter 116 sends the transformed image assets or image information output, which is also translated from the input DSL to the chosen native rendering language of the communication device 136, for display in or in association with the layout and position output 220 to the communication device 136. Simultaneously, the data mapper 120 sends data information to the server 132, which stores and processes the data information using an API to then generate a data binding output. The data binding output can be in the native rendering language of either the server or communication device. The communication device 136 can have a bi-directional communication, via link 160, with the server 132, and therefore, the communication device 136 receives the necessary data binding output to populate containers in the layout and position output on the communication device 136, which combines all three outputs in the native rendering language for display on the communication device 136.

The bi-directional communication via link 160 in this embodiment allows for the communication device 136 to send data to the server 132. Therefore, if a user manipulates data on the communication device 136, for example, a mobile phone, then the communication device 136 can send the relevant data updates to the sever 132, and the server 132 maintains an authoritative copy of the data information. If there are conflicts between the data on the communication device 136 and the data on the server 132, a hierarchical system may be utilized to resolve conflicts. In one embodiment, changes to data on the communication device 136 are tracked using a time stamp and are tagged with metadata that indicates whether the change in data is a critical state change (immutable), a non-critical update (potentially mergable), or a new object altogether. Conflict resolutions such as destructive removals, additions, and object replacement will occur on the server 132 depending on the tagged metadata. Further, the changes will occur in the order they are received by the server 132.

According to one embodiment, a transportable object can be created and used to store state information for one or more of the plurality of objects on the communication device 136 that have experienced a change in state. For example, if the user of the communication device 136, e.g., through manipulation of the interface, clicks a button, sends a message, modifies, creates, or deletes a file, or takes some other action, a transportable object capturing that action can be created and information about the action can be stored in that object. The transportable object can then be used to transmit that state information to the server 132.

The server 132 can receive such transportable objects from one or more client communication devices when the state of an object on that device changes. The server 132 can then use that information to maintain a user state between multiple clients on which the DSL is rendered. To maintain this user state, the server 132 can automatically merge conflicts between client communication devices and between the client communication devices and the server, synchronize object state between the clients and server, and automatically commit changes.

More specifically, the server 132 can maintain a user state information 175 such as a registry for each user as a discrete instance of that user. Generally speaking, this registry can be stored by the server 132 in a repository of user state information 175 and can comprise a list of change transactions which can reflect the user state at any given time based on those transactions. The server 132 can also comprise a synchronization module 165 that can receive transportable objects from a synchronization module 170 on the client communication device 136 based on actions by the user on the device 135 related to one of the plurality of objects on that device which result in an update to that object. Each update to an individual object contained within the user state can cause the synchronization module 170 of the communication device 136 to store changes as an atomic change list. Each change list can maintain time-stamp information and metadata that can be used to track whether the update is a critical state change (i.e., is immutable), a non-critical update (i.e., is potentially mergable), or a new object. Once these updates are received by the server 132 through a transportable object, the atomic change lists can be applied in the order they are received by the synchronization module 165 of the server 132 to the user state information 175 maintained by the server. Conflicts created by actions such as destructive removals, additions, object replacements, etc. can be resolved based on the metadata of the change list, e.g., the type of change, the time of the change, etc.

According to one embodiment, the client communication device 136 can locally maintain a set of one or more synchronization records 180 comprising a previously transmitted state for each of the plurality of objects on the client. When synchronization or transmission occurs or is desired, the synchronization module 170 of the client communication device 136 can use the synchronization records 180 to compute differences between the previously transmitted state and the current state of the objects on the device 136 as a series of data transforms which can be used to generate markup metadata that describes the changes since the last transmitted state. An example of such metadata will be described in detail below but, generally speaking, can include metadata indicating the type of change made, when the change was made, and may include data of the change itself such as content of a message, etc. This markup metadata can be included in a transportable object for transmission to the server 132. When received by the server, the markup metadata can be translated by the synchronization module 165 of the server back into the series of data transformations which can then be applied to the user state information 175 maintained by the server 175.

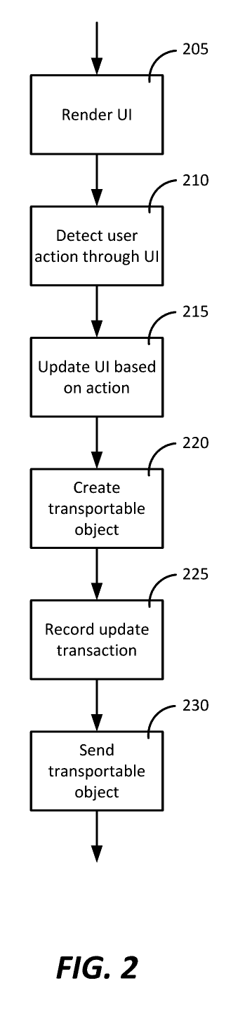

FIG. 2 is a flowchart illustrating an exemplary client device process for object compression and state synchronization according to one embodiment. As illustrated in this example, synchronizing a user state between a client device and a server, from the perspective of the client device, can begin with rendering 205 a user interface on the client device. The user interface, such as an interface defined in DSL as described in detail above, can represent a plurality of objects on the client device. The plurality of objects can be related to an application executing on a server.

A user action through the rendered user interface can be detected 210. The user action can be related to at least one of the plurality of objects on the client device and can change a state of the at least one of the plurality of objects. For example, the user action can comprise anything from a click of a button represented in the user interface to the sending of a message such as an email or social media post, or even the editing, creation, or deletion of a file. In response to the detected 210 user action, and as can be understood, the user interface can be updated 215 on the device to reflect the action and result of that action.

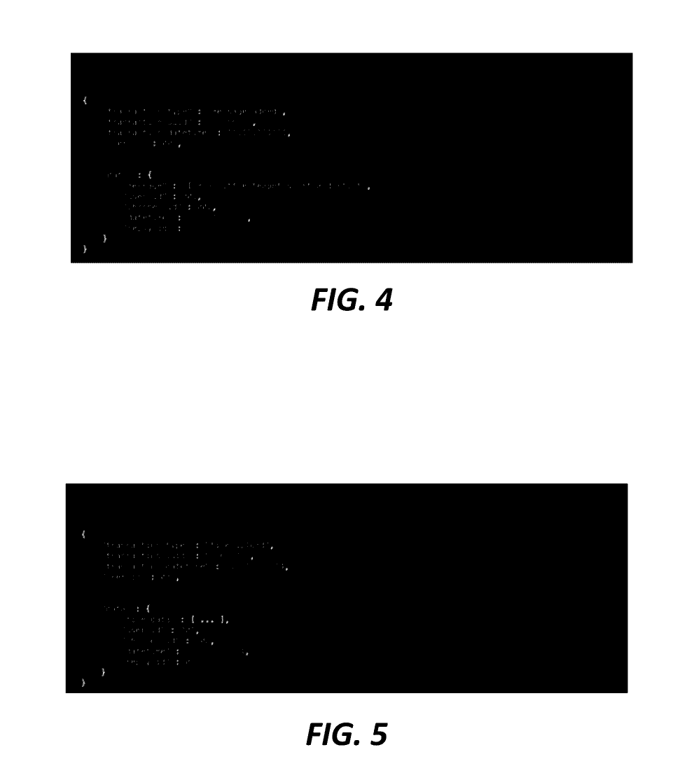

A transportable object can be created 225 based on the detected user action. The transportable object can comprise information describing the changing of the state of the at least one of the plurality of objects and can represent a current user state for the user relative to the application, i.e., based on that change. For example, the transportable object can comprise metadata identifying one or more of a transaction type, a unique transaction identifier, a transaction timestamp for the time when the transaction occurred, a user identifier for the user, or content of the transaction. Additionally or alternatively, the transportable object can comprise metadata identifying a change to the object as a critical state change that is immutable, a non-critical update that is potentially mergable, or a creation of a new object. Further examples, of metadata defining a transportable object will be described below with reference to FIGS. 4-6.

According to one embodiment, creating 225 the transportable object based on the detected user action can be further based on stored information describing the previous user state sent to the server. In such cases, creating 225 the transportable object based on the stored information describing the previous user state sent to the server can further comprise determining differences between the current user state and the previous user state sent to the server, defining the determined differences between the current user state and the previous user state sent to the server as a series of data transforms, and generating metadata of the transportable object describing the series of data transforms.

In either case, whether the transportable object is created 220 based on a difference between a previous state and the current state or on the current state alone, information describing the user state can be recorded 225. When communication with the server is available, the created transportable object describing the user sate can be sent 230 to the server

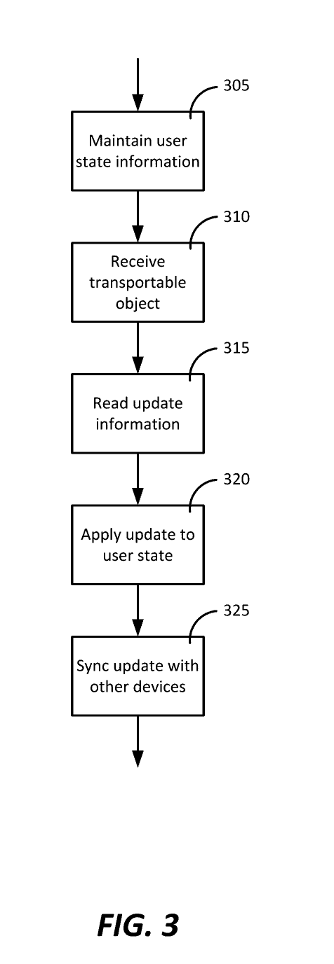

FIG. 3 is a flowchart illustrating an exemplary server process for object compression and state synchronization according to one embodiment. As illustrated in this example, synchronizing a user state between a client device and a server, from the perspective of the server, can begin with maintaining 305 as a discrete instance, user state information for each user from a plurality of users of an application.

A transportable object can be received 310. The transportable object can comprise information describing a change of a state by a user of the plurality of users of the at least one of the plurality of objects on the client device and related to an application on the server. The transportable object can represent a current user state for the user relative to the application. For example, the transportable object can comprise metadata identifying one or more of a transaction type, a unique transaction identifier, a transaction timestamp for the time when the transaction occurred, a user identifier for the user, or content of the transaction. In some cases, the received transportable object can comprise metadata describing changes to the state of the at least one of the plurality of objects since a last synchronization.

The information describing the change of the state of the at least one of the plurality of objects can be read 315 from the received transportable object. An update can be applied 320 to the maintained user state information for the user based on the information the information describing the change of the state of the at least one of the plurality of objects received in the transportable object. For example, when the received metadata describes changes since a last synchronization, applying 320 the update to the maintained user state information for the user based on the information describing the change of the state of the at least one of the plurality of objects received in the transportable object can comprise translating the metadata of the received transportable object to a series of data transforms and applying the series of data transforms to the maintained user state information for the user. Applying the update to the maintained user state information for the user can also comprise resolving, by the server, conflicts between destructive removals, additions, and object replacements represented by the metadata of the transportable object. According to one embodiment, applying the update to the maintained user state information for the user can further comprise synchronizing 325 the user state with one or more client communication devices for the user.

FIG. 4 is an exemplary code snippet illustrating contents of a transportable object according to one embodiment. More specifically, this example illustrates some exemplary metadata that can be included in a transportable object in the event that the user of the client device posts a message, e.g., an email, a social media post, etc. This metadata can include attribute-value pairs identifying, for example, a transaction type, a unique transaction identifier, a transaction timestamp for the time when the transaction occurred, and a user identifier for the user initiating the transaction. The metadata can also include one or more attribute-value pairs identifying the content of the transaction such as the content of the message itself, a channel identifier or other indication of how the message was sent, an identifier of a corresponding reply, etc. In other examples, more or less metadata may be included in the content of the transportable object. Any such variations are considered to be within the scope of the present disclosure.

FIG. 5 is an exemplary code snippet illustrating contents of a transportable object according to another embodiment. More specifically, this example illustrates some exemplary metadata that can be included in a transportable object in the event that the user of the client device updates a file. This metadata can include attribute-value pairs identifying, for example, a transaction type, a unique transaction identifier, a transaction timestamp for the time when the transaction occurred, and a user identifier for the user initiating the transaction. The metadata can also include one or more attribute-value pairs identifying the content of the transaction such as the content of the file itself, a channel identifier or other indication of how the message was sent, an identifier of a corresponding reply, etc. In other examples, more or less metadata may be included in the content of the transportable object. Any such variations are considered to be within the scope of the present disclosure.

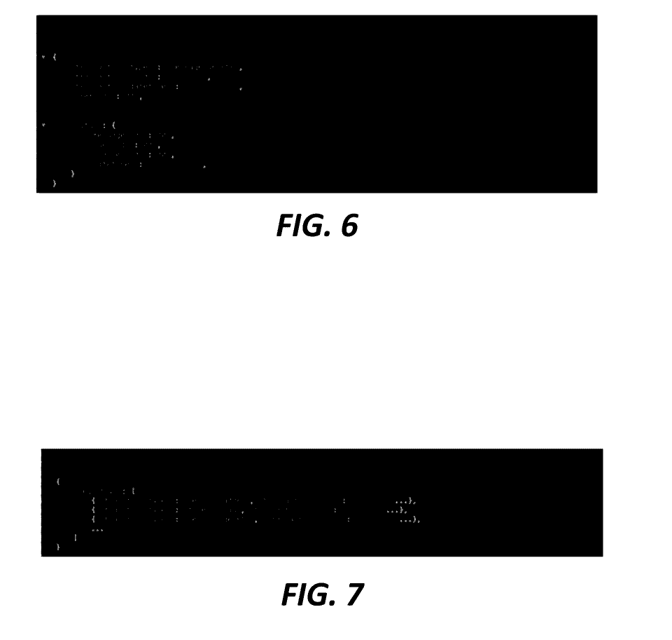

FIG. 6 is an exemplary code snippet illustrating contents of a transportable object according to yet another embodiment. More specifically, this example illustrates some exemplary metadata that can be included in a transportable object in the event that the user of the client device removes or deletes a message, e.g., an email, a social media post etc. This metadata can include attribute-value pairs identifying, for example, a transaction type, a unique transaction identifier, a transaction timestamp for the time when the transaction occurred, and a user identifier for the user initiating the transaction. The metadata can also include one or more attribute-value pairs identifying the content of the transaction such as a unique identifier for the message, a channel identifier or other indication of how the transaction occurred, etc. In other examples, more or less metadata may be included in the content of the transportable object. Any such variations are considered to be within the scope of the present disclosure.

FIG. 7 is an exemplary code snippet illustrating contents of a registry for a user according to one embodiment. According to one embodiment, the registry can comprise a list of transactions for each user which can represent and which can be used to recreate the user state at any given point in time. As illustrated in this example, the registry can comprise a list of transaction entries in the order in which the corresponding transactions were received. Each transaction entry can comprise the metadata from the transportable object such as the attribute-value pairs for the transaction type, transaction identifier, etc. Such a registry can be stored locally on the client device and, when a connection is available, can be transmitted to the server for storage thereon. Using this metadata, the server can then replicate the user state on any one or more other devices for the user.

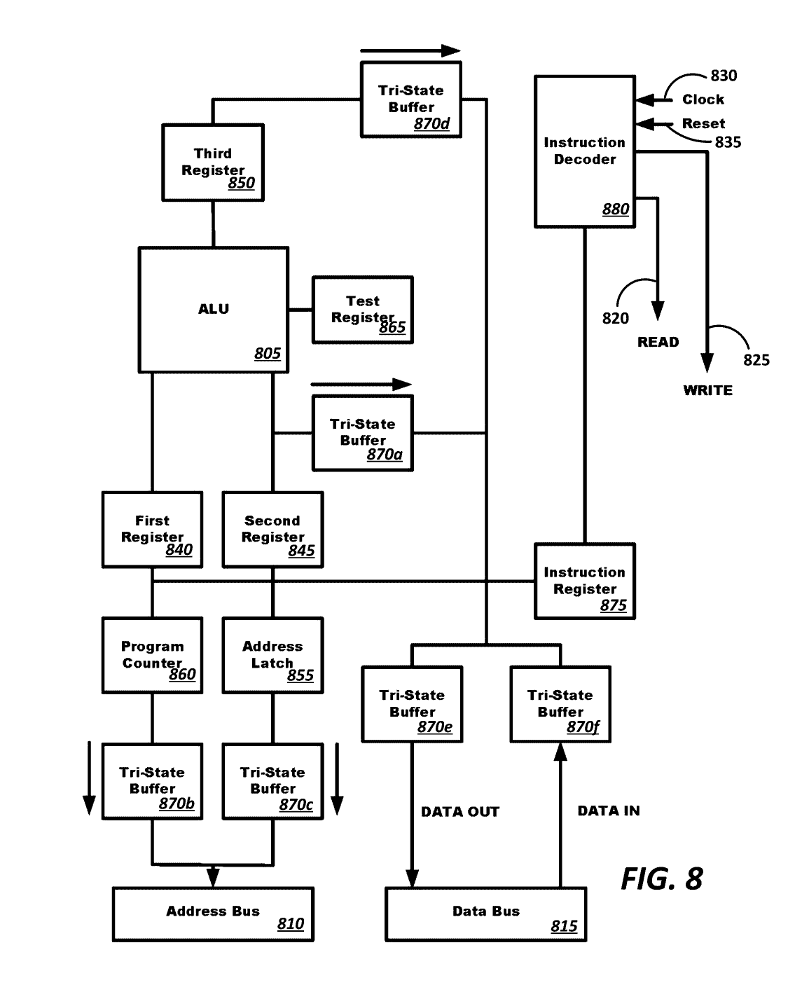

FIG. 8 is a block diagram illustrating an exemplary hardware system upon which elements of the present disclosure may be implemented. For example, the container style and/or layout transformer 112, view formatter 116, and/or container data mapper 120 or any of the other elements illustrated in FIG. 1 can be executed by the arithmetic/logic unit (“ALU”) 805, which performs mathematical operations, such as addition, subtraction, multiplication, and division, machine instructions, an address bus 810 (that sends an address to memory), a data bus 815 (that can send data to memory or receive data from memory), a read and write line 820 and 825 to tell the memory whether to set or get the addressed location, a clock line 830 that enables a clock pulse to sequence the processor, and a reset line 835 that resets the program counter to zero or another value and restarts execution. The arithmetic/logic unit 805 can be a floating point processor that performs operations on floating point numbers. The arithmetic/logic unit 805 is in communication with first, second, and third registers 840, 845, and 850 that are typically configured from flip-flops, an address latch 855, a program counter 860 (which can increment by “1” and reset to “0”), a test register 865 to hold values from comparisons performed in the arithmetic/logic unit 805 (such as comparisons of any of the identifiers referenced above), plural tri-state buffers 870a-f to pass a “1” or “0” or disconnect its output (thereby allowing multiple outputs to connect to a wire but only one of them to actually drive a “1” or “0” into the line), and an instruction register 875 and decoder 880 to control other components. Control lines from the instruction decoder can: command the first register to latch the value currently on the data bus, command the second register to latch the value currently on the data bus, command the third register to latch the value currently output by the ALU, command the program counter register to latch the value currently on the data bus, command the address register to latch the value currently on the data bus, command the instruction register to latch the value currently on the data bus, command the program counter to increment, command the program counter to reset to zero, activate any of the plural tri-state buffers (plural separate lines), command the ALU what operation to perform, command the test register to latch the ALU's test bits, activate the read line, and activate the write line. Bits from the test register and clock line as well as the bits from the instruction register come into the instruction decoder. The ALU executes instructions for the container style and/or layout transformer 112, view formatter 116, and/or container data mapper 120.

Any of the steps, functions, and operations discussed herein can be performed continuously and automatically.

The exemplary systems and methods of this disclosure have been described in relation to a distributed processing network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a processor; and
a memory coupled with the processor and comprising a set of instructions stored therein which, when executed by the processor, causes the processor to synchronize a user state between a client device and a server by:
rendering a user interface on the client device, the user interface representing a plurality of objects on the client device, the plurality of objects related to an application executing on a server;
detecting a user action through the rendered user interface, the user action related to at least one of the plurality of objects on the client device and changing a state of the at least one of the plurality of objects;
creating a transportable object based on the detected user action and comprising information describing the changing of the state of the at least one of the plurality of objects and representing a current user state for the user relative to the application; and
sending the transportable object to the server.

2. The system of claim 1, wherein the transportable object comprises metadata identifying one or more of a transaction type, a unique transaction identifier, a transaction timestamp for the time when the transaction occurred, a user identifier for the user, or content of the transaction.

3. The system of claim 1, wherein the instructions further cause the processor to store information describing a previous user state sent to the server.

4. The system of claim 3, wherein creating the transportable object based on the detected user action is further based on the stored information describing the previous user state sent to the server.

5. The system of claim 4, wherein creating the transportable object based on the stored information describing the previous user state sent to the server further comprises:
determining differences between the current user state and the previous user state sent to the server;
defining the determined differences between the current user state and the previous user state sent to the server as a series of data transforms; and
generating metadata of the transportable object describing the series of data transforms.

6. A system comprising:
a processor; and
a memory coupled with the processor and comprising a set of instructions stored therein which, when executed by the processor, causes the processor to synchronize a user state between a client device and a server by:
maintaining user state information for each user from a plurality of users of an application as a discrete instance of the user;
receiving a transportable object comprising information describing a change of a state of the at least one of the plurality of objects related to an application on a client device by a user of the plurality of users and representing a current user state for the user relative to the application;
reading, from the received transportable object, the information describing the change of the state of the at least one of the plurality of objects; and
applying an update to the maintained user state information for the user based on the information the information describing the change of the state of the at least one of the plurality of objects received in the transportable object.

7. The system of claim 6, wherein the transportable object comprises metadata identifying one or more of a transaction type, a unique transaction identifier, a transaction timestamp for the time when the transaction occurred, a user identifier for the user, or content of the transaction.

8. The system of claim 6, wherein the received transportable object comprises metadata describing changes to the state of the at least one of the plurality of objects since a last synchronization.

9. The system of claim 8, wherein applying the update to the maintained user state information for the user based on the information describing the change of the state of the at least one of the plurality of objects received in the transportable object further comprises:
translating the metadata of the received transportable object to a series of data transforms; and
applying the series of data transforms to the maintained user state information for the user.

10. The system of claim 6, wherein applying the update to the maintained user state information for the user further comprises synchronizing the user state with one or more client communication devices for the user.

11. A method for synchronizing a user state between a client device and a server, the method comprising:
rendering, by the client device, a user interface on the client device, the user interface representing a plurality of objects on the client device, the plurality of objects related to an application executing on a server;
detecting, by the client device, a user action through the rendered user interface, the user action related to at least one of the plurality of objects on the client device and changing a state of the at least one of the plurality of objects;
creating, by the client device, a transportable object based on the detected user action and comprising information describing the changing of the state of the at least one of the plurality of objects and representing a current user state for the user relative to the application; and
sending, by the client device, the transportable object to the server.

12. The method of claim 11, further comprising:
maintaining, by the server, user state information for each user from a plurality of users of an application as a discrete instance of the user;
receiving, by the server, the transportable object from the client;
reading, by the server, from the received transportable object, the information describing the change of the state of the at least one of the plurality of objects; and
applying, by the server, an update to the maintained user state information for the user based on the information describing the change of the state of the at least one of the plurality of objects received in the transportable object.

13. The method of claim 12, wherein applying the update to the maintained user state information for the user comprises resolving, by the server, conflicts between destructive removals, additions, and object replacements represented by the metadata of the transportable object.

14. The method of claim 12, wherein the transportable object comprises metadata identifying one or more of a transaction type, a unique transaction identifier, a transaction timestamp for the time when the transaction occurred, a user identifier for the user, or content of the transaction.

15. The method of claim 12, wherein the transportable object comprises metadata identifying a change to the object as a critical state change that is immutable, a non-critical update that is potentially mergable, or a creation of a new object.

16. The method of claim 12, further comprising storing, by the client device, information describing a previous user state sent to the server.

17. The method of claim 16, wherein creating the transportable object based on the detected user action is further based on the stored information describing the previous user state sent to the server.

18. The method of claim 17, wherein creating the transportable object based on the stored information describing the previous user state sent to the server further comprises:
determining, by the client device, differences between the current user state and the previous user state sent to the server;
defining, by the client device, the determined differences between the current user state and the previous user state sent to the server as a series of data transforms; and
generating, by the client device, metadata of the transportable object describing the series of data transforms.

19. The method of claim 18, wherein applying the update to the maintained user state information for the user based on the information describing the change of the state of the at least one of the plurality of objects received in the transportable object further comprises:
translating, by the server, the metadata of the received transportable object to a series of data transforms; and
applying, by the server, the series of data transforms to the maintained user state information for the user.

20. The method of claim 19, wherein applying the update to the maintained user state information for the user further comprises synchronizing the user state with one or more client communication devices for the user.
